(19) United States
(12) Patent Application Publication
(10) Pub. No.: US 2024/0091883 A1
(43) Pub. Date: Mar. 21, 2024

(54) Process Monitor for Laser Processing Head

(71) Applicant: II-VI Delaware, Inc., Wilmington, DE (US)

(72) Inventor: Danny CHAN, Berlin (DE)

(21) Appl. No.: 17/933,807

(22) Filed: Sep. 20, 2022

(51) Int. Cl. B23K 26/70; B23K 26/06; B23K 26/073; B23K 26/38

(52) U.S. Cl. CPC B23K 26/705; B23K 26/0643; B23K 26/0648; B23K 26/073; B23K 26/38

(57) ABSTRACT

A laser processing head conducts laser energy to process a workpiece. A fiber input emits the laser energy, and internal optics focus the laser energy as a laser beam to a focus spot relative to an output on the head. A relay between the fiber input and the internal optics directs a portion of process light, which has returned from the process through the internal optics to the relay. The effects of the internal optics form the returned process light as a hollow converging cone toward the fiber input. The relay is located in an angular space situated an extent outside the diverging cone of the emitted laser energy from the fiber input, such as at a numerical aperture that is about 10 percent greater than the numerical aperture of the fiber input. A sensor detects the portion of the process light directed to it.

### BACKGROUND OF THE DISCLOSURE

A laser processing head, such as used for cutting or material processing, can provide a high-power laser beam of 10 kW and even up to 30 kW. The laser material processing head often uses adjustable optics, such as zoom optics, for adjusting the focus of the laser beam.

During laser material processing, a process sensor (e.g., a piercing sensor) is often used to monitor the process. To achieve this, process light from the process zone must reach the process sensor located on the head. However, the process zone of interest may be very far away from the focus point of the optics so it can be difficult to obtain light from the process zone at the process sensor.

Also, for some laser material processing applications (e.g., cutting applications or remote welding applications utilizing a scanner system), the focus position may be dynamically adjusted. In this case, the signal at the process sensor may be influenced not only by process variations but also by the intended adjustments of the spot position of the laser beam.

In a two-dimensional cutting head, cutting gas mechanics are used with a nozzle of the head to control the cutting gas directed toward the workpiece to be cut. The cutting gas mechanics are designed to even out and maximize the flow of cutting gas to the process zone. Therefore, the cutting gas mechanics are typically dimensioned to be close to the maximum possible laser beam outline. For this reason, the cutting gas mechanics define a limiting aperture that restricts what process light can be reflected from the process back through the cutting head.

A common arrangement for process monitoring in a laser cutting head uses a folding mirror (e.g., a dichroic mirror) positioned in the collimated beam inside the head. A sensor and optics are located behind the folding mirror. In this arrangement, the sensor is coaxial with the optical axis of the process and can monitor the process light that passes through the folding mirror. However, this arrangement requires a great deal of space and adds significant weight to the laser cutting head.

Another arrangement for process monitoring in a laser cutting head also uses a folding mirror (e.g., a dichroic mirror), but the mirror is positioned between the input fiber and the collimator lens inside the head. The folding mirror in this position directs process light to a sensor, but the mirror can require a significant amount of space. In any event, because the laser light from the fiber tip passes through the folding mirror, the properties of the folding mirror tend to influence the optical design of the head. Additionally, the folding mirror encounters very high-intensity light emitted from the input fiber.

Another arrangement for process monitoring in a laser cutting head uses a sensor embedded in the laser light cable or embedded in the laser source itself to detect the process light reflected back. An example is disclosed in US 2020/0298334. This arrangement can be costly and can impact the quality of the laser source.

The subject matter of the present disclosure is directed to overcoming, or at least reducing the effects of, one or more of the problems set forth above.

### SUMMARY OF THE DISCLOSURE

A laser processing head disclosed herein conducts laser energy to a process on a workpiece. The laser processing head comprises a fiber input, an adjustable optical system, an output, and a process monitor. The fiber input emits the laser energy along an optical axis, and the adjustable optical system disposed on the optical axis is configured to focus the laser energy as a laser beam. The adjustable optical system includes one or more adjustable optical elements. An initial one of the one or more adjustable optical elements is disposed between the fiber input and any other of the one or more adjustable optical elements. The output is disposed on the optical axis through which the laser beam is configured to pass to a focus spot. The process monitor is configured to sense a portion of process light, which has returned from the process through at least a portion of the adjustable optical system to a sensing position. The sensing position is disposed laterally from the optical axis and is positioned in the portion of the process light outside the laser beam. The sensing position is disposed longitudinally along the optical axis and is positioned between the fiber input and the initial adjustable optical element.

A laser processing head disclosed herein conducts laser energy to a process on a workpiece. The laser processing head comprises a fiber input, an adjustable optical system, an output, and one or more sensors. The fiber input emits the laser energy along an optical axis, and the adjustable optical system disposed on the optical axis is configured to focus the laser energy as a laser beam. The adjustable optical system includes one or more adjustable optical elements. An initial one of the one or more adjustable optical elements is disposed between the fiber input and any other of the one or more adjustable optical elements. The output is configured to pass the laser beam to a focus spot. The one or more sensors are configured to sense a portion of process light, which has returned from the process through at least a portion of the adjustable optical system to a sensing position. The sensing position is disposed laterally from the optical axis and is positioned in the portion of the process light outside the laser beam. The sensing position is disposed longitudinally along the optical axis and is positioned between the fiber input and the initial adjustable optical element.

A laser processing head disclosed herein conducts laser energy to a process on a workpiece. The laser processing head comprises a fiber input, an adjustable optical system, an output, a relay, and one or more sensors. The fiber input emits the laser energy along an optical axis, and the adjustable optical system disposed on the optical axis is configured to focus the laser energy as a laser beam. The adjustable optical system includes one or more adjustable optical elements. An initial one of the one or more adjustable optical elements is disposed between the fiber input and any other of the one or more adjustable optical elements. The output disposed on the optical axis is configured to pass the laser beam to a focus spot. The relay is positioned in a sensing position between the fiber input and the initial adjustable optical element. The relay is configured to direct a portion of process light, which has returned from the process through at least a portion of the adjustable optical system to the sensing position. The sensing position is disposed laterally from the optical axis and is positioned in the portion of the process light outside the laser beam. The sensing position is disposed longitudinally along the optical axis and is positioned between the fiber input and the initial adjustable optical element. One or more sensors in optical communication with the relay are configured to detect the portion of the process light directed thereto.

A laser processing method disclosed herein comprises: conducting laser energy to a process on a workpiece by: emitting the laser energy from a fiber input of a head, focusing the laser energy as a laser beam using an adjustable optical system of the head, and passing the laser beam through an output of the head to a focus spot, the adjustable optical system including one or more adjustable optical elements, an initial one of the one or more adjustable optical elements being disposed between the fiber input and any other of the one or more adjustable optical elements; and monitoring the process by detecting a portion of process light, which has returned from the process through at least a portion of the adjustable optical system to a sensing position, the sensing position being disposed laterally from the optical axis and being positioned in the portion of the process light outside the laser beam, the sensing position being disposed longitudinally along the optical axis and being positioned between the fiber input and the initial adjustable optical element.

The foregoing summary is not intended to summarize each potential embodiment or every aspect of the present disclosure.

### BRIEF DESCRIPTION OF THE DRAWINGS

FIG. 1 illustrates an example of a laser processing head that can use a process monitor according to the present disclosure.

FIG. 2A illustrates a schematic view of a laser processing head having a process monitor according to the present disclosure.

FIG. 2B illustrates the laser processing head of FIG. 2A in another operating condition.

FIG. 3 illustrates a schematic view of a laser processing head having the disclosed process monitor.

FIG. 4 illustrates a schematic view of another laser processing head having the disclosed process monitor.

FIG. 5 illustrates a schematic view of yet another laser processing head having a process monitor according to the present disclosure.

FIG. 6A-6B illustrate schematic views of a portion of a laser processing head having process monitors of the present disclosure.

FIG. 7A illustrates a process monitor of the present disclosure having an optical collector.

FIG. 7B illustrates a process monitor of the present disclosure having opposing reflective rings.

FIG. 7C illustrates a process monitor of the present disclosure having a contoured scraper mirror.

FIG. 8 illustrates a process monitor of the present disclosure having an aperture plate with a reflective edge.

### DETAILED DESCRIPTION OF THE DISCLOSURE

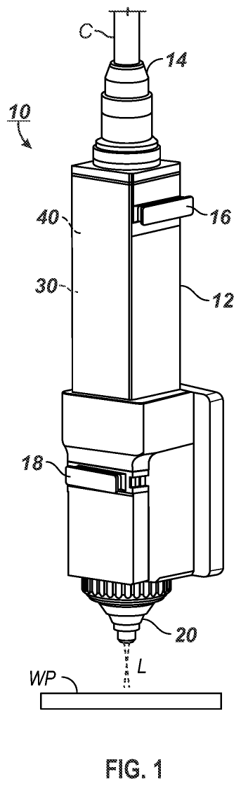

FIG. 1 illustrates a laser processing head 10 that can use a process monitor 40 according to the present disclosure. The laser processing head 10 is used to conduct a laser operation, such as laser cutting, welding, soldering, surface treatment, tactile brazing, additive manufacturing processes, and the like. For example, the laser processing head 10 can be a laser cutting head used to cut a workpiece WP with an emitted laser beam L.

The laser processing head 10 includes a housing 12 that holds an adjustable optical system 30. A receptacle or receiver 14 at one end of the housing 12 couples to a laser cable C, which conducts laser energy into the head 10. A laser source (not shown) generates high-power laser light that is propagated along the fiber optic cable C to the receptacle 14. Internally, the adjustable optical system 30, which has at least one adjustable optical element, focuses the laser energy into a laser beam L, which is directed to a workpiece WP to achieve cutting, brazing, welding, additive manufacturing, or some other lasing process. The fiber of the cable C can be single-core or multi-core fiber, and the laser beam L can have any desired shape. For example, the laser beam L can be a ring-shaped laser beam, such as used in cutting applications of thick materials.

As shown, the output end of the housing 12 can have a nozzle 20 that allows the focused laser beam L and any process gas to be emitted from the housing 12 during the laser operation. Meanwhile, the laser processing head 10 can be moved relative to the workpiece WP and/or can have the workpiece WP moved relative to it. For example, the laser processing head 10 can be moved by a gantry system, robotic arm, or other apparatus (not shown) used in the art.

To protect the adjustable optical system 30 inside the housing 12, the head 10 may include a cover slide cartridge 18 that holds a replaceable cover slide. This cover slide acts as a transparent window between the interior of the housing 12 (having the adjustable optical system 30) and the external environment (exposed to the laser process at the workpiece WP). An access door in the side of the head 10 permits the removal and replacement of the cartridge 18. Another cover slide cartridge 16 may also be provided between the receptacle 14 and the adjustable optical system 30 to protect the adjustable optical system 30 from contamination and debris. The nozzle 20 also protects the laser cutting head 10.

During operations, the process monitor 40 inside the housing 12 is configured to monitor process light returned from the process (at the interaction of the laser beam L and the workpiece WP) that returns through the housing 12 and the adjustable optical system 30 to the process monitor 40. In general, the process monitor 40 can be positioned on either side of the cover slide 16. However, the process monitor 40 is positioned above any adjustable optical element of the adjustable optical system 30. In that sense, any optical elements can be positioned above the process monitor 40 as long as these optical elements are not adjustable and actuated.

The laser processing head 10 can then be controlled based on the monitored process light detected by the process monitor 40. Preferably, the process monitor 40 for the head 10 has a small volume inside the processing head 10 so the process monitor 40 only requires a limited amount of space within the housing 12. Also, the process monitor 40 preferably does not impose a specific geometry on the head 10, as is required when using a folding mirror inside a head. Further, the process monitor 40 preferably can be used with the adjustable optical system 30 and can monitor the process independent of the adjustments to the adjustable optical elements of the adjustable optical system 30.

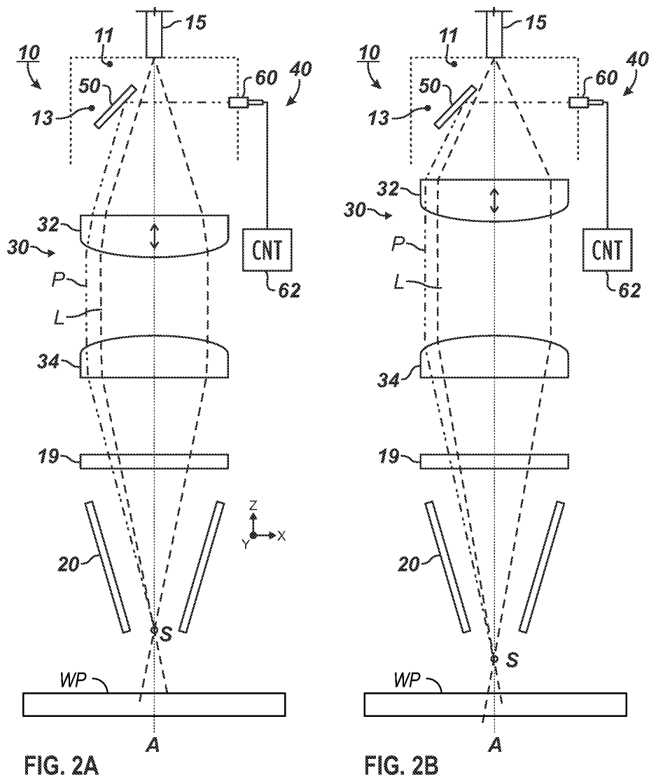

FIG. 2A illustrates a schematic view of a laser processing head 10 having a process monitor 40 according to the present disclosure, and FIG. 2B illustrates the laser processing head 10 of FIG. 2A in another operational condition. The head 10 includes an input 15 for the laser energy and includes the adjustable optical system 30 for directing a laser beam L from the nozzle 20 of the head 10. The input 15 emits the laser energy along an optical axis A, and the adjustable optical system 30 disposed on the optical axis A is configured to focus the laser energy as the laser beam L, which passes from the head's nozzle 20 to a focus spot S.

As shown, the adjustable optical system 30 can include one or more optical elements 32, 34, and the nozzle 20 for output of the laser beam L can be separated by a cover slide 19 from the adjustable optical system 30. As noted, the input 15, the adjustable optical system 30, the cover slide 19, and the like are disposed in a housing (not shown) of the head 10. Meanwhile, the nozzle 20 extends from the housing of the head 10 to emit the laser beam L and any process gas toward the workpiece WP.

In general, the adjustable optical system 30 can include one or more adjustable optical elements, and an initial one of the one or more adjustable optical elements is disposed between the fiber input 15 and any other of the one or more adjustable optical elements. The process monitor 40 is configured to sense a portion of process light P, which has returned from the process through at least a portion of the adjustable optical system 30 to a sensing position 13. The sensing position 13 is disposed laterally from the optical axis A and is positioned in the portion of the process light P outside the laser beam L. The sensing position 13 is disposed longitudinally along the optical axis A and is positioned between the fiber input 15 and the initial adjustable optical element.

In the present example shown in FIGS. 2A-2B, for example, the adjustable optical system 30 includes one adjustable optical element. In some embodiments of the head 10, as in the example of FIGS. 2A-2B, the first optical element or lens 32 adjacent to the input 15 can be adjustable and can be moved by actuation, while the second optical element 34 toward the output of the head 10 is fixed. (FIGS. 2A-2B show the first adjustable optical element 32 adjusted to different positions along the optical axis A.)

The process monitor 40 is positioned “above” or “before” the first adjustable optical element 32 along the optical axis A. In particular, the process monitor 40 is positioned in a sensing position 13 disposed in a space 11 between the input 15 and the first adjustable optical element 32. However, other arrangements can be used. (“Above,” “before,” etc. are merely used for convenience to describe the arrangement and positions of the input 15, elements 32, 34, process monitor 40, and the like along the optical path or axis A of the head 10.)

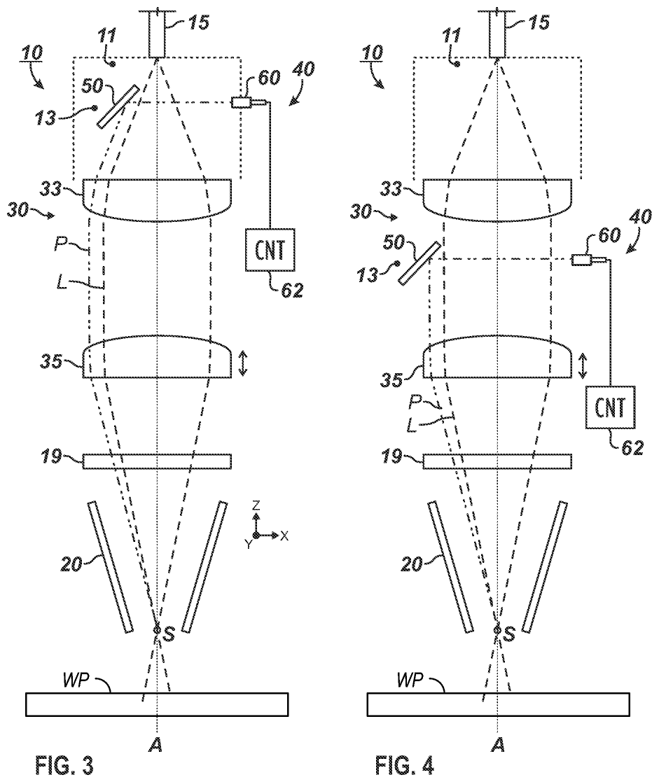

In another example, the process monitor 40 can be positioned as shown in FIG. 3A between a first optical element 33 and the input 15. However, the first optical element 33 can be fixed, while a second optical element 35 can be adjustable and can be moved by actuation. In other words, the process monitor 40 is still positioned “above” or “before” the initial adjustable optical element 35 in FIG. 3. In fact, as shown in FIG. 4, the process monitor 40 can be positioned between the fixed optical element 33 and the initial adjustable optical element 35 in an alternative arrangement for the head 10.

During operation of the head 20 in FIGS. 2A-2B, the input 15 (e.g., a high-power laser delivery fiber) in the head 10 emits a high-power laser beam L in the head 10, which passes along the optical axis A through the adjustable optical system 30. From the adjustable optical system 30, the laser beam L is focused to pass through the protective cover slide 19 and then to the nozzle 20. The laser beam L is focused to the focal point or spot S, and the laser beam L then impinges on or near a workpiece WP or some other desired process zone for the laser operation. Depending on the laser process, the focal spot S can be located at or near the workpiece WP, can be located in the exit plane of the nozzle 20 as in FIG. 2A, or can be located at some other location along the optical axis that suits the process at hand.) For example, FIG. 2B illustrates the laser processing head 10 of FIG. 2A with the laser beam L focused to the focal spot S located outside the nozzle 20.

The laser processing head 10 can be used in a laser process in which the focal spot S of the laser beam L can be adjusted in the optical axis A relative to the workpiece WP. For instance, the one or more second movable lens element 34 permits the focal spot S of the laser beam L to be adjusted along the optical axis A in the Z-direction. In this way, the focal spot S can be adjusted to the different contours of the workpiece WP or to different process zones needed for the laser process. This adjustment along the optical axis A can be performed while the head 10 remains stationary relative to the workpiece WP, while the head 10 moves in the X-Y plane relative to the workpiece WP, while the head 10 is also moved along the Z-direction, or when a combination of such movements are performed.

For example, the laser processing head 10 as a laser cutting head uses the laser beam L to perform cutting operations on the workpiece WP, such as sheets of different materials. The laser cutting process requires precise control of the cutting head 10 and requires particular control of the gap between the tip of the cutting head's nozzle 20 (where the laser beam L exits) and the surface of the material being cut (i.e., the workpiece WP), as well as requiring particular control of the position of the laser focus point S relative to the workpiece WP. In addition, specific beam shapes, a lateral decentralization of the laser beam L in the nozzle 20, or a change in magnification may be beneficial for cutting the particular material. For this purpose, the laser cutting head 10 uses the adjustable optical system 30 for controlling the cutting process. Other sensors, such as a capacitive height sensor of the nozzle 20, are used for controlling other aspects of the cutting process.

In general terms, the laser cutting head 10 converts the energy of a high-power laser source (typically a CO₂ or YAG laser) into the laser beam L able to cut through (sever) a metal sheet WP in a precise, controlled manner. The cutting head 10 may pass the laser beam L through the series of lenses 32, 34, which focus the laser beam L to the focal spot S sized for the cutting process. The focused beam is directed through the nozzle 20 of the cutting head 10 and toward the sheet of material WP to be cut.

At the same time, a companion gas (typically nitrogen or oxygen and referred to at times as a cutting or process gas) is also delivered from the nozzle 20 to the surface of the workpiece WP along with the laser beam L. The cutting gas functions either to assist in the melting process (e.g., “oxy-fuel burning process”) or to help blow molten material away from the workpiece WP. For example, the cutting gas can blow material away from the nozzle 20 and down through the cutting kerf so the material is ejected from the bottom of the workpiece WP. Meanwhile, the nozzle 20 is typically positioned at a particular standoff from the workpiece WP to achieve proper cutting and to avoid molten material contaminating the nozzle 20 and the cutting head 10.

To monitor such a laser process, the head 10 includes the process monitor 40 as shown in FIGS. 2A-2B, 3, and 4, which includes at least one optical sensor 60. In the present example, a relay 50 is positioned in the sensing position 13 between the fiber input 15 and the initial adjustable optical element of the adjustable optical system 30. In FIGS. 2A-2B, for example, the relay 50 is positioned in the sensing position 13 between the fiber input 15 and the initial adjustable optical element 32. In FIG. 3, the relay 50 is positioned in the sensing position 13 between the fiber input 15 and the optical element 33 so that the relay 50 is still “above” or “before” the initial adjustable optical element 35. In FIG. 4, the relay 50 is positioned in the sensing position 13 between the optical element 33 and the adjustable optical element 35 so that the relay 50 is still “above” or “before” the initial adjustable optical element 35.

The relay 50 directs the portion of the process light P to the at least one sensor 60, which is in optical communication with the relay 50 and is configured to detect the portion of the process light P directed thereto. In FIGS. 2A-2B and 3, the relay 50 can be at least one reflector, such as a scraper mirror, positioned in the space 11 between the fiber tip 15 and the first optical element (32 or 33) of the adjustable optical system 30 in the head 10. In FIG. 4, the relay 50 can be at least one reflector, such as a scraper mirror, positioned in the space 11 between the optical elements (33 and 35) of the adjustable optical system 30 in the head 10. If there is enough room in the space 11, the at least one sensor 60 can be located directly at the appropriate sensing position 13 instead of requiring the use of the relay 50.

This space 11 is typically limited inside the housing of the head 10. The space 11 may not have any particular shape and can simply encompass any normal three-dimensional area that is free or available in the housing of the head 10 where a sensor or reflector can be located that looks to a specific angular space of the beam cone of the returning process light P. The space 11 available for locating the relay 50 lies outside of the diverging cone of the laser beam L between the fiber input 15 and the lens element 32. In a general sense, this available space 11 in FIGS. 2A-2B and 3 is an angular or conical type of volume or area that is restricted by the inner dimensions and shape of the surrounding housing. In FIG. 4, this available space 11 is a cylindrical type of volume or area that is restricted by the inner dimensions and shape of the surrounding housing.

The relay 50 as a scraper mirror is preferably composed of a metal material having a highly-reflective coating. The at least one optical sensor 60 can include one or more photodiodes, an infrared camera, a high-speed camera, a spectrometer, a pyrometer, or another type of optical sensing element to detect a property (e.g., intensity) of the returned process light P.

The process light P reflected from the process travels back to the relay 50 through the adjustable optical system 30, which has reversible optical effects on the process light P. Therefore, the relay 50 sees at least a section of a hollow cone or cylinder of the returned process light P imaged around the emitted laser beam L. Exposure to the section of the hollow cone or cylinder can be sufficient for most sensing operations, but the relay 50 and other components of the process monitor 40 can have a more elaborate arrangement to sense more or less of a complete 360-degree ring around the cone or cylinder of the process light P. The hollow cone or cylinder of the process light P will always have the same relative size (numerical aperture) to the laser beam L emitted between the input 15 of the first optical element 32, regardless of the actual settings of the adjustable optical system 30. Because all apertures in the head 10 have to be designed slightly oversized so that the largest possible beam generated by the adjustable optical system 30 can pass through the head 10 unobstructed, this cone or cylinder of process light P will also always be unobstructed.

As noted above, the relay 50 for directing the process light P is positioned in the sensing position 13 in the space 11 “above,” “before,” or “upbeam” any adjustable optical element or lens of the adjustable optical system 30 and is positioned in a path of the process light P slightly adjacent to the laser beam L. As described, the adjustable optical system 30 includes one or more optical elements or lenses—at least one of which is adjustable. The process monitor 40 uses the sensor 60 to monitor the process light P “above,” “before,” “upbeam,” etc. of any initial adjustable optical element of the system 30. If the initial adjustable optical element is the last element in the system 30 toward the output of the head 30 as in FIG. 4, then process monitor 40 uses the sensor 60 to monitor the process light P at any sensing position 13 convenient for implementation that is upstream or above that element. This sensing position 13 can be exactly above the adjustable optical element 32 as in FIGS. 2A-2B or exactly above the adjustable optical element 35 as in FIG. 3. If there are any non-adjustable optical elements before, the sensing position 13 can be at any suitable position along the optical axis A, as in FIG. 3 or 4.

Yet, a default sensing position 13 is in the upper space 11 above the first optical element, as in FIGS. 2A, 2B, and 3. Because the process light P is transmitted mostly uniformly towards the head 10, there will always be process light P in this upper space 11. All of the manipulation of the laser beam L by the adjustable optical system 30 occurs in the head 10 below this upper space 11. Therefore, the process light P will also undergo the same manipulation of the adjustable optical system 30 in reverse. The process sensor 60 will always see the process light P returned in the same way—i.e., as a converging light cone around the diverging light cone of the laser beam L. The sensor 60, therefore, can see the process light P returned along the laser beam's outline at/within the material of the workpiece WP.

As noted, the process sensor 60 can be a photodiode, an infrared camera, a high-speed camera, a spectrometer, a pyrometer, or another type of optical sensing element to detect and measure a property (e.g., intensity) of the process light P incident thereto. A controller 62 connected to the sensor 60 can determine one or more desired characteristics of the cut (or another process) based on the detected process light. The characteristics can include intensity, frequency of fluctuations, penetration, kerf, defects, quality, etc., and can be used to monitor the cutting (or another process) produced by the laser beam L at the workpiece WP. In one example, the controller 62 can use photodiodes of the sensor 60 to determine the cut quality in real-time, and the controller 62 can use adaptive feedback control to increase the cutting velocity or to improve the cutting quality. In another example, the controller 62 can detect when the piercing is done to initiate the cutting process.

As shown in FIG. 2A, the focus of the laser beam L is at or inside the nozzle 20. The process light P is imaged by the adjustable optical system 30 to the relay 50 (e.g., scraper mirror), which directs a portion of the process light P to the sensor 60. As shown in FIG. 2B, however, the focal spots S of the laser beam L is outside (i.e., below) the nozzle 20. Yet, because the imaging by the adjustable optical system 30 can be inverted and reversed, the process light P will come back to the relay 50 at the same position and angle.

In FIGS. 2A-2B and 3, the relay 50, such as the scraper mirror described above, is positioned at an increased numerical aperture (NA) from the numerical aperture (NA) of the fiber tip 15. In one configuration, the relay 50 can be set at 10% beyond the numerical aperture of the fiber tip 15. In this way, the relay 50 will encounter a converging cone of the process light P returned by the adjustable optical system 30 that is about 10% larger than the diverging cone of the laser beam L from the fiber tip 15. In one particular example, the laser beam L exiting the fiber tip 15 can have a numerical aperture (NA) of 120 mrad. The relay 50 (e.g., scraper mirror) can be located to encounter process light P at a numerical aperture (NA) of 132 mrad (e.g., 10% larger). In this way, the one or more sensors 60 in communication with the scraper mirror 50 can detect light from a hollow cone with an aperture angle 10% larger than the laser beam L. This imaging can be achieved regardless of any adjustment by the adjustable optical system 30, because the optical effects of the system 30 are reversible.

In FIG. 4, the relay 50, such as the scraper mirror, is positioned at an increased numerical aperture (NA) from the numerical aperture (NA) of the fiber tip 15 and fixed optical element 33. In one configuration, the relay 50 can be set at 10% beyond the numerical aperture of the fiber tip 15 and fixed optical element 33. In this way, the relay 50 will encounter a hollow cylinder of the process light P returned by the adjustable optical system 30 that is about 10% larger than the cylindrical collimated laser beam L from the fiber tip 15 and fixed optical element 33.

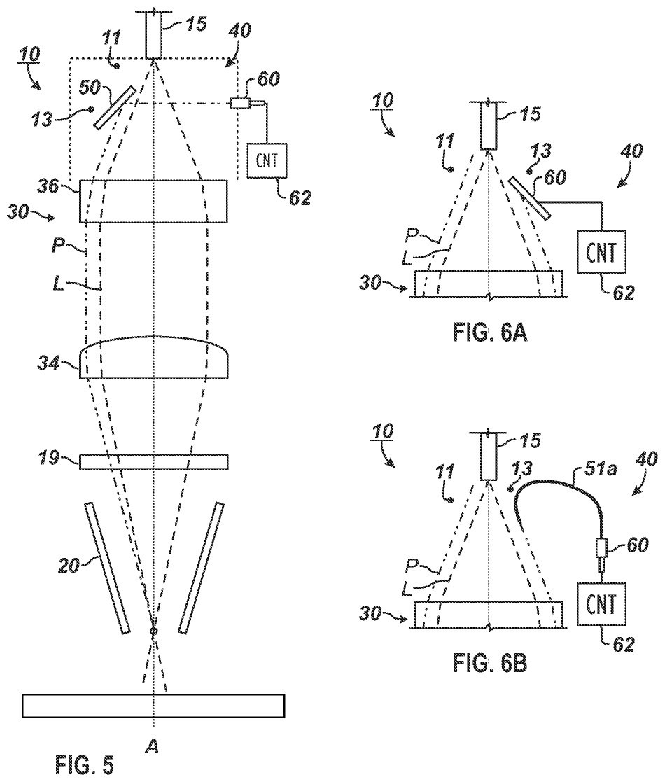

FIG. 5 illustrates a schematic view of another laser processing head 10 having a process monitor 40 of the present disclosure. In this example, the adjustable optical system 30 of the head 10 includes complex zoom optics 36, which are adjustable to change the magnification of the laser beam L. Examples of the zoom optics 36 are disclosed in DE 102011117607 and DE 102019108084, which are incorporated herein by reference.

The zoom optics 36 can adjust the focal diameter and focal length of the laser beam L. Depending on the adjustments by the zoom optics 36, the laser beam L can have a smaller or larger outer diameter. However, the hollow cone of the process light P above the zoom optics 36 is the same size (numerical aperture) because the process light P travels through the zoom optics 36 of the adjustable optical system 30 in a reverse direction. This allows the process monitor 40 to operate in a similar manner as described above.

The arrangements of FIGS. 2A-2B, 3, 4, and 5 are only schematically shown. As will be appreciated with the benefit of the present disclosure, the relay 50 (e.g., scraper mirror) can direct a portion of the returned process light P in another direction than shown. In particular, the relay 50 (e.g., scraper mirror) can direct the portion of the process light P so that it does not cross the emitted laser beam L.

Additionally, other arrangements of the process monitor 40 can be used. The relay 50 can be integrated into other components, in particular an aperture, in the head 10. If space allows, a relay (e.g., a reflector, a mirror, etc.) may not be used, and a sensor 60 can be located directly at the sensing position 13 in the space 11 to monitor the process light P.

As mentioned above, the relay 50 (e.g., reflector, mirror, etc.) is not necessary. Instead, if the space 11 allows, the sensor 60 of the process monitor 40 can be placed in the appropriate positions. For example, FIG. 6A illustrates a schematic view of a portion of a laser processing head 10 having another process monitor 40 of the present disclosure. In this configuration, the process monitor 40 includes one or more sensors 60 positioned in the angular space 11 and disposed directly in the path of the hollow cone of the returned process light P. This arrangement can eliminate the need for a reflector or scraper mirror as in other configurations.

In general, the process monitor 40 can use a relay 50, such as a reflector, a scraper mirror, an optical glass fiber, or another type of relay component, to couple the sensing position 13 with the sensor 60 when the placement of the sensor 60 needs to be situated away from the sensing position 13. For example, FIG. 6B shows yet another configuration for the process monitor 40 where the relay 51a is an optical glass fiber. An input end of the optical glass fiber 51a can be placed at this sensing position 13 and can relay the optical signal to the sensor 60. In the most general sense, the process monitor 40 of the present disclosure includes the sensing position 13 along the beam path and the sensor 60.

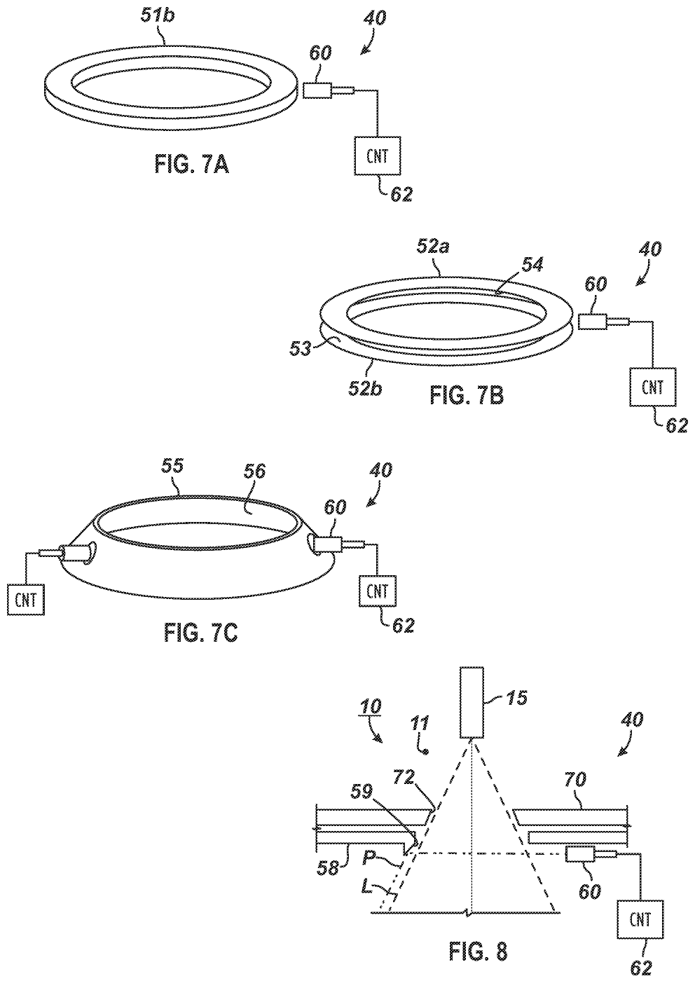

FIG. 7A illustrates another embodiment of the process monitor 40 of the present disclosure. In this configuration, the process monitor 40 uses an optical collector 51b for the relay to image the process light to one or more process sensors 60. The optical collector 51b can be composed of optical glass or another appropriate material. The process light P incident to the bottom surface of the collector 51b can be reflected internally between its opposing top and bottom surfaces toward one or more sensors 60 arranged at the edge of the collector 51b.

FIG. 7B illustrates another embodiment of the process monitor 40 of the present disclosure. In this configuration, the process monitor 40 uses opposing reflective surfaces or rings 52a-b for the relay to image the process light to one or more process sensors 60. The rings 52a-b can be composed of metal and can have highly-reflective coatings on their facing surfaces 53. The lower ring 52b has a larger opening 54 than the upper ring 52a. The process light incident to the upper ring 52a can be reflected between the opposing surfaces 53 of the two rings 52a-b toward one or more sensors 60 arranged at the edge of the rings 52a-b.

FIG. 7C illustrates an alternative to the process monitor 40 of the present disclosure. In this configuration, the process monitor 40 uses a contoured scraper mirror 55 for the relay to image the process light to the one or more process sensors 60. The contoured scraperscraper mirror 55 is frusto-conical and has a reflective surface 56 that can encompass a circumference around the laser beam (L) allowed to pass through its center. The sensors 60 can be situated at different circumferential locations to detect portions of the process light (P) reflected from opposing portions of the reflective surface 56 of the scraperscraper mirror 55. Although not necessarily depicted, the sensors 60 sense radially towards the center of the mirror 55. For this configuration, the mirror 55 can be a monolithic scraper mirror or can be separate mirror sections. The reflective surface of this mirror 55 can be machined into a part of the housing of the head 10 so that independent elements of the mirror 55 thereof do not need to be handled and assembled during fabrication.

FIG. 8 illustrates yet another embodiment of the process monitor 40 of the present disclosure. In this configuration, the processing head (10) includes an aperture plate 70 that can be composed of a suitable metal material and can be cooled. The aperture plate 70 includes an aperture 72 therein for passage of the laser beam L. The inner circumference of the aperture 72 on the plate 70 is intended to prevent the passage of stray light from the fiber tip 15 from passing to the adjustable optical system (30).

As either part of the aperture plate 70 or as a separate element, a scraper plate 58 has an inside edge 59 for reflecting at least a portion of the process light P to the one or more sensors 60 of the process monitor 40. This scraper plate 58 can be composed of a suitable metal material and can have a highly-reflective coating on at least a portion of the inside edge 59 that defines an angle. The inside edge 59 of the scraper plate's opening can be set at an increase of about 10% beyond an effective numerical aperture. In this case, the effective numerical aperture is not the numerical aperture of the laser beam from the input 15. Instead, the effective numerical aperture is defined by the aperture 72 itself because this aperture 72 should already be the smallest hole in the system.

The foregoing description of preferred and other embodiments is not intended to limit or restrict the scope or applicability of the inventive concepts conceived of by the Applicants. It will be appreciated with the benefit of the present disclosure that features described above in accordance with any embodiment or aspect of the disclosed subject matter can be utilized, either alone or in combination, with any other described feature, in any other embodiment or aspect of the disclosed subject matter.

What is claimed is:

1. A laser processing head to conduct laser energy to a process on a workpiece, the laser processing head comprising:
a fiber input emitting the laser energy along an optical axis;
an adjustable optical system disposed on the optical axis and configured to focus the laser energy as a laser beam, the adjustable optical system including one or more adjustable optical elements, an initial one of the one or more adjustable optical elements being disposed between the fiber input and any other of the one or more adjustable optical elements;
an output disposed on the optical axis through which the laser beam is configured to pass to a focus spot; and
a process monitor configured to sense a portion of process light, which has returned from the process through at least a portion of the adjustable optical system to a sensing position, the sensing position being disposed laterally from the optical axis and being positioned in the portion of the process light outside the laser beam, the sensing position being disposed longitudinally along the optical axis and being positioned between the fiber input and the initial adjustable optical element.

2. The laser processing head of claim 1, wherein the process monitor comprises one or more sensors positioned in the sensing position between the fiber input and the initial adjustable optical element and being configured to sense the portion of the process light.

3. The laser processing head of claim 1, wherein the process monitor comprises:
a relay positioned in the sensing position between the fiber input and the initial adjustable optical element, the relay being configured to direct the portion of the process light; and
one or more sensors in optical communication with the relay and being configured to detect the portion of the process light directed thereto.

4. The laser processing head of claim 3, wherein the relay comprises a reflector, a mirror, or an optical glass fiber.

5. The laser processing head of claim 3, wherein the relay comprises a scraper mirror disposed at an angle relative to the optical axis.

6. The laser processing head of claim 5, wherein the scraper mirror is disposed in a converging cone of the process light converging from the initial adjustable optical element toward the fiber input.

7. The laser processing head of claim 6, wherein the scraper mirror defines a frusto-conical shape.

8. The laser processing head of claim 3, wherein the relay comprises:
a plate disposed between the fiber input and the internal optics, the plate defining an aperture through which a diverging cone of the laser energy emitted from the fiber input passes to the internal optics; and
a reflective portion of the plate disposed at the aperture and being configured to direct the portion of process light to the one or more sensors.

9. The laser processing head of claim 3, wherein the relay comprises first and second opposing surfaces configured to reflect the portion of the process light between them toward an edge of the reflector; and wherein the one or more sensors are disposed at the edge of the reflector and are configured to detect the portion of the process light directed thereto.

10. The laser processing head of claim 3, wherein one or more sensors are selected from the group consisting of a photodiode, an infrared camera, a high-speed camera, a spectrometer, and a pyrometer.

11. The laser processing head of claim 1, wherein the fiber input has a first numerical aperture; and wherein the sensing position is disposed at a second numerical aperture that is greater than or equal to the first numerical aperture of the fiber input.

12. The laser processing head of claim 11, wherein the second numerical aperture is at least 10 percent greater than the first numerical aperture.

13. The laser processing head of claim 1, wherein the adjustable optical system comprises:
a movable lens element as the initial adjustable optical element disposed in the head adjacent to the fiber tip; and
a fixed lens element disposed in the head between the movable lens element and the output.

14. The laser processing head of claim 1, wherein the one or more adjustable optical elements comprise a zoom optic system.

15. The laser processing head of claim 1, wherein the output comprises a nozzle.

16. A laser processing head to conduct laser energy to a process on a workpiece, the laser processing head comprising:
a fiber input emitting the laser energy along an optical axis;
an adjustable optical system disposed on the optical axis and configured to focus the laser energy as a laser beam, the adjustable optical system including one or more adjustable optical elements, an initial one of the one or more adjustable optical elements being disposed between the fiber input and any other of the one or more adjustable optical elements;
an output through which the laser beam is configured to pass to a focus spot; and
one or more sensors configured to sense a portion of process light, which has returned from the process through at least a portion of the adjustable optical system to a sensing position, the sensing position being disposed laterally from the optical axis and being positioned in the portion of the process light outside the laser beam, the sensing position being disposed longitudinally along the optical axis and being positioned between the fiber input and the initial adjustable optical element.

17. The laser processing head of claim 16, wherein the one or more sensors are disposed at an angle in a space adjacent to a diverging cone of the laser energy emitted from the fiber input to the internal optics.

18. The laser processing head of claim 17, wherein the one or more sensors are disposed in a converging cone of the process light converging from the initial adjustable optical element toward the fiber input.

19. The laser processing head of claim 17, wherein the fiber input has a first numerical aperture; and wherein the one or more sensors are disposed at a second numerical aperture that is greater than the first numerical aperture of the fiber input.

20. The laser processing head of claim 19, wherein the second numerical aperture is at least 10 percent greater than the first numerical aperture.

21. A laser processing head to conduct laser energy to a process on a workpiece, the laser processing head comprising:
a fiber input emitting the laser energy along an optical axis;
an adjustable optical system disposed on the optical axis and configured to focus the laser energy as a laser beam, the adjustable optical system including one or more adjustable optical elements, an initial one of the one or more adjustable optical elements being disposed between the fiber input and any other of the one or more adjustable optical elements;
an output disposed on the optical axis through which the laser beam is configured to pass to a focus spot;
a relay positioned in a sensing position between the fiber input and the initial adjustable optical element, the relay being configured to direct a portion of process light, which has returned from the process through at least a portion of the adjustable optical system to the sensing position, the sensing position being disposed laterally from the optical axis and being positioned in the portion of the process light outside the laser beam, the sensing position being disposed longitudinally along the optical axis and being positioned between the fiber input and the initial adjustable optical element; and
one or more sensors in optical communication with the relay and being configured to detect the portion of the process light directed thereto.

22. A laser processing method comprising:
conducting laser energy to a process on a workpiece by: emitting the laser energy from a fiber input of a head, focusing the laser energy as a laser beam using an adjustable optical system of the head, and passing the laser beam through an output of the head to a focus spot, the adjustable optical system including one or more adjustable optical elements, an initial one of the one or more adjustable optical elements being disposed between the fiber input and any other of the one or more adjustable optical elements; and
monitoring the process by detecting a portion of process light, which has returned from the process through at least a portion of the adjustable optical system to a sensing position, the sensing position being disposed laterally from the optical axis and being positioned in the portion of the process light outside the laser beam, the sensing position being disposed longitudinally along the optical axis and being positioned between the fiber input and the initial adjustable optical element.

23. The method of claim 22, wherein detecting the portion of the process light, which has returned from the process through the internal optics to the angular space between the fiber input and the internal optics comprises:
reflecting the portion of the process light with a reflector positioned in the angular space between the fiber input and the internal optics; and
sensing the reflected portion of the process light with one or more sensors in optical communication with the reflector.

24. The method of claim 22, wherein detecting the portion of the process light, which has returned from the process through the internal optics to the angular space between the fiber input and the internal optics comprises sensing the portion of the process light with one or more sensors positioned in the angular space between the fiber input and the internal optics.
